(19) United States
(12) Patent Application Publication
(10) Pub. No.: US 2005/0274599 A1
(43) Pub. Date: Dec. 15, 2005

(54) Gas treating method and apparatus

(75) Inventors: Junichi Tamura, Tokyo (JP); Yoshiaki Kaneko, Tokyo (JP); Toshiji Nishiguchi, Kawasaki-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/149,139

(22) Filed: Jun. 10, 2005

(30) Foreign Application Priority Data
Jun. 15, 2004 (JP) 2004-176857

(51) Int. Cl. B01D 53/00

(52) U.S. Cl. 204/157.3

(57) ABSTRACT

Provided is a gas treating method, including: generating non-equilibrium plasma in a gas flow space; and treating a gas to be treated containing a substance to be treated using the non-equilibrium plasma, the non-equilibrium plasma being generated by using at least two wire-like high-voltage applying electrodes that are arranged away from each other, in between at least two flat-plate ground electrodes that are arranged face to face in parallel to each other to define the gas flow space, in a direction perpendicular to opposite sides of the flat-plate ground electrodes.

### BACKGROUND OF THE INVENTION

1. Field of the Invention

The present invention relates to a gas treating method and apparatus using non-equilibrium plasma.

2. Related Background Art

In recent years, there have been growing concerns about air pollution due to a gas containing a substance to be treated such as a volatile compound and about influences thereof to human bodies. Among various techniques for treating such a gas containing the substance to be treated etc., which have been proposed so far, attentions focus on a technique for treating a gas containing a volatile organic compound (VOCs) etc. through plasma discharge, especially non-equilibrium plasma discharge. A gas treating method and apparatus based on this technique have been proposed.

A parallel-plate plasma apparatus 101 shown in FIG. 7 typifies a gas treating apparatus of this type. The parallel-plate plasma apparatus includes: flat-plate ground electrodes 111a and 111b supported by barrier materials 115a and 115b, respectively, and arranged in parallel; a flat-plate high-voltage applying electrode 116 placed in between the opposing flat-plate ground electrodes 111a and 111b; and a power supply 113 for applying voltage to the flat-plate ground electrodes 111a and 111b.

Further, there has been disclosed (in Japanese Patent Application Laid-Open No. 2002-50500) as the parallel-plate gas treating apparatus, a parallel-plate packed-bed type reactor 102 as shown in FIG. 8. This reactor is composed of: the flat-plate ground electrodes 111a and 111b supported by the barrier materials 115a and 115b, respectively, and arranged in parallel; the flat-plate high-voltage applying electrode 116 placed in between the opposing flat-plate ground electrodes 111a and 111b; and particles of an inorganic dielectric 114 packed between the flat-plate high-voltage applying electrode 116 and each of the flat-plate ground electrodes 111a and 111b. Reference numeral 113 denotes the power supply as in FIG. 7.

The parallel-plate plasma apparatus 101 and the parallel-plate packed-bed type reactor 102 generate plasma discharge between the high-voltage applying electrode 116 and each of the flat-plate ground electrodes 111a and 111b, and introduce a gas to be treated “a”, thereby treating a substance to be treated in the gas to be treated “a” and discharging the resultant gas as a treated gas “b”.

Both the conventional apparatuses, the parallel-plate plasma apparatus 101 and parallel-plate packed-bed reactor 102, can operate under atmospheric pressure, dispense with a pump and other such devices for evacuating the apparatus, and generate plasma discharge at room temperature. In addition, the parallel-plate plasma apparatus 101 and parallel-plate packed-bed reactor 102 are advantageous in simple apparatus structure, low installation cost, and ease of upsizing.

However, in the case of using the flat-plate high-voltage applying electrode placed in parallel to the flat-plate ground electrodes as in the conventional apparatuses, high electric field intensity is necessary for dielectric breakdown. Hence, it is disadvantageously required to arrange each flat-plate ground electrode closer to each flat-plate high-voltage applying electrode or apply a higher voltage to the flat-plate high-voltage applying electrode in order to generate non-equilibrium plasma discharge. As a result, the conventional parallel-plate apparatuses involve a problem in that a reaction vessel having a gas flow space is relatively small, and a power supply portion is relatively high in cost and large in size.

### SUMMARY OF THE INVENTION

The present invention has been made to solve the above-described problems, and it is therefore an object of the present invention to provide a gas treating method and apparatus for treating a gas containing a substance to be treated, which achieve reduction in electric field intensity requisite for dielectric breakdown and secure a large gas flow space.

In order to attain the aforementioned object, one aspect of the present invention relates to a gas treating method, including: generating non-equilibrium plasma in a gas flow space; and treating a gas containing a substance to be treated using the non-equilibrium plasma, the non-equilibrium plasma being generated by using at least two wire-like high-voltage applying electrodes that are arranged away from each other, in between at least two flat-plate ground electrodes that are arranged face to face in parallel to each other to define the gas flow space, in a direction perpendicular to opposite sides of the flat-plate ground electrodes.

Further, another aspect of the present invention relates to a gas treating apparatus having a gas flow space for generating non-equilibrium plasma to treat a gas containing a substance to be treated, including: at least two flat-plate ground electrodes that are arranged face to face in parallel to each other to define the gas flow space; and at least two wire-like high-voltage applying electrodes that are arranged away from each other, in between the opposing flat-plate ground electrodes, in a direction perpendicular to opposite sides of the flat-plate ground electrodes.

According to the above-mentioned aspects of the present invention, the high-voltage applying electrodes are formed into a wire shape, whereby plasma discharge can be generated efficiently at relatively low electric field intensity. Further, according to the present invention, at least two wire-like high-voltage applying electrodes are arranged away from each other in a direction perpendicular to opposite sides of the flat-plate ground electrodes, whereby a large gas flow space can be ensured while keeping the electric field intensity relatively low.

Note that in the present invention, volatile organic compounds (VOCs), nitrogen oxides, and an offensive odor substance are given as examples of the substance to be treated. However, the present invention is not limited thereto and is aimed at treating any gaseous substances.

According to the present invention, non-equilibrium plasma is generated by using at least two wire-like high-voltage applying electrodes that are arranged away from each other, in between two opposing flat-plate ground electrodes, in a direction perpendicular to opposite sides of the flat-plate ground electrodes, whereby a large gas flow space can be secured while achieving reduction in electric field intensity necessary for dielectric breakdown. Consequently, according to the present invention, the substance to be treated in the gas can be efficiently treated.

### BRIEF DESCRIPTION OF THE DRAWINGS

FIG. 1 is a sectional view schematically showing a gas treating apparatus according to First Embodiment of the present invention;

FIG. 2 is a sectional view schematically showing a gas treating apparatus according to Second Embodiment of the present invention;

FIG. 3 is a sectional view schematically showing a gas treating apparatus according to Third Embodiment of the present invention;

FIG. 4 is a sectional view schematically showing a gas treating apparatus according to Fourth Embodiment of the present invention;

FIG. 5 shows a relationship between an interval between wire-like high-voltage applying electrodes and a decomposition ratio according to Example 3 of the present invention;

FIG. 6 shows a relationship between an interval between wire-like high-voltage applying electrodes and a decomposition ratio according to Example 4 of the present invention;

FIG. 7 is a sectional view schematically showing a conventional parallel-plate plasma apparatus; and

FIG. 8 is a sectional view schematically showing a conventional parallel-plate packed-bed type reactor.

### DESCRIPTION OF THE PREFERRED EMBODIMENTS

Hereinafter, embodiments of the present invention will be described in detail with reference to the accompanying drawings.

A gas treating apparatus according to the embodiments of the present invention is used for decomposing a gas to be treated containing a substance to be treated as a gaseous substance such as volatile organic compounds (VOCs), nitrogen oxides, and an offensive odor substance into the substance to be treated and the gas (treated gas).

### First Embodiment

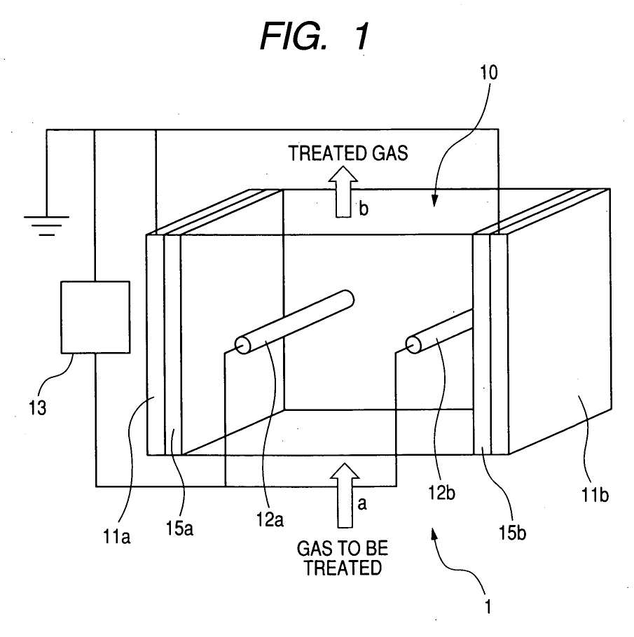

FIG. 1 shows a gas treating apparatus to which a gas treating method according to First Embodiment is applied.

As shown in FIG. 1, a gas treating apparatus 1 of this embodiment includes a reaction vessel (not shown) having a gas flow space 10 where a gas containing a substance to be treated is treated by generating non-equilibrium plasma. The gas treating apparatus further includes: at least two flat-plate ground electrodes 11a and 11b that are arranged face to face in parallel to each other to define the gas flow space 10; two wire-like high-voltage applying electrodes 12a and 12b that are arranged away from each other, in between the two opposing flat-plate ground electrodes 11a and 11b, in a direction perpendicular to opposite sides of the flat-plate ground electrodes 11a and 11b; and a power supply 13 for applying a voltage across the flat-plate ground electrodes 11a and 11b, and the wire-like high-voltage applying electrodes 12a and 12b.

The two flat-plate ground electrodes 11a and 11b are arranged on inner wall surfaces of the reaction vessel and laminated with barrier materials 15a and 15b, respectively on opposite sides thereof. The two wire-like high-voltage applying electrodes 12a and 12b are arranged such that an axial direction thereof extends in parallel to the opposite sides of the flat-plate ground electrodes 11a and 11b and extends orthogonally to a gas flow direction. In addition, used for the wire-like high-voltage applying electrodes 12a and 12b is a wire whose diameter is 5 mm or smaller, preferably 1 mm or smaller. This advantageously produces an effect of concentratedly applying an electric field to lower a dielectric breakdown voltage. Further, when the wire-like high-voltage applying electrodes 12a and 12b have the diameter larger than 5 mm, the high dielectric breakdown voltage is undesirably required.

Moreover, an interval between the wire-like high-voltage applying electrodes 12a and 12b that are arranged away from each other in a direction perpendicular to the opposite sides of the flat-plate ground electrodes 11a and 11b is set 0.5 to 20 times larger than a distance between the flat-plate ground electrodes 11a, 11b and the wire-like high-voltage applying electrodes 12a, 12b closest to the flat-plate ground electrodes 11a and 11b, respectively. This preferably produces an effect of generating uniform plasma discharge throughout the gas flow space 10. If the interval between the wire-like high-voltage applying electrodes 12a and 12b is below 0.5 times the above distance, there is a drawback that no discharge takes place between the wire-like high-voltage applying electrodes 12a and 12b. The interval that is above 20 times the distance involves a similar drawback.

The gas treating apparatus 1 thus structured separates the substance to be treated through decomposition as below. When a gas to be treated “a” containing the substance to be treated is introduced into the gas flow space 10 of the gas treating apparatus 1, voltage is applied to the two wire-like high-voltage applying electrodes 12a and 12b by the power supply 13. In this way, non-equilibrium plasma is generated between the wire-like high-voltage applying electrode 12a and the flat-plate ground electrode 11a through the barrier material 15a and between the wire-like high-voltage applying electrode 12b and the flat-plate ground electrode 11b through the barrier material 15b. The non-equilibrium plasma separates the substance to be treated from the gas to be treated “a” flowing through the gas flow space 10, and the remaining gas is discharged to the outside of a treatment system as a treated gas “b”. Note that any waveform such as a sine waveform, a pulse waveform, a triangular waveform, and a rectangular waveform can be adopted for the power supply 13 with no particular limitation. The barrier materials 15a, 15b can be formed of any dielectric material with no particular limitation. In addition, there is no particular limitation on whether to use the barrier materials or not.

With the above gas treating apparatus 1, the electric field intensity necessary for dielectric breakdown can be lowered while ensuring the large gas flow space 10 in the reaction vessel by using the two wire-like high-voltage applying electrodes 12a and 12b arranged away from each other, in between the two flat-plate ground electrodes 11a and 11b that are arranged face to face in parallel to each other, in a direction perpendicular to opposite sides of the flat-plate ground electrodes 11a and 11b. Therefore, the gas treating apparatus 1 can efficiently treat the substance to be treated in the gas to be treated “a”.

Hereinafter, a gas treating apparatus according to another embodiment will be described with reference to the drawings. Note that the illustrated gas treating apparatus of the other embodiment as will be described below has almost the same basic structure as the gas treating apparatus 1 of First Embodiment shown in FIG. 1. Thus, the same components as in FIG. 1 are denoted by like reference symbols and their description is omitted here.

### Second Embodiment

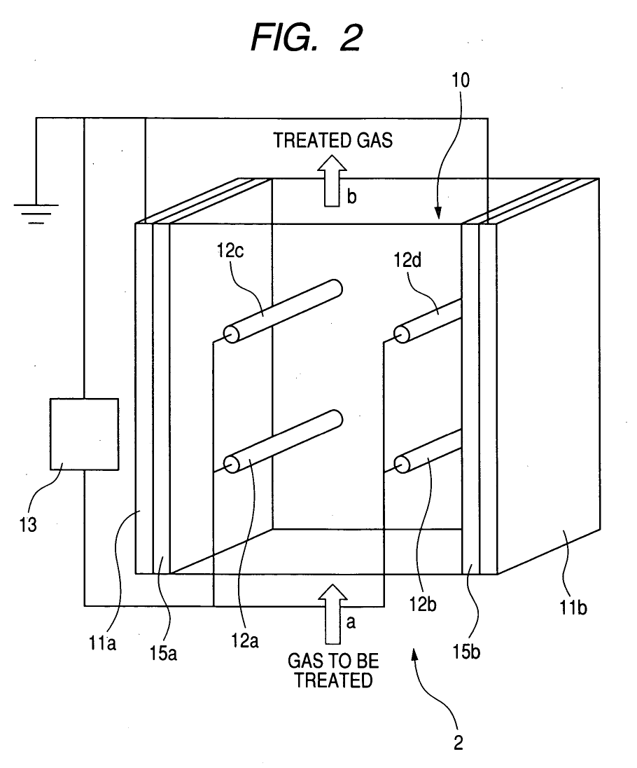

FIG. 2 is a sectional view showing a gas treating apparatus to which a gas treating method according to Second Embodiment is applied. As shown in FIG. 2, a gas treating apparatus 2 of this embodiment includes four wire-like high-voltage applying electrodes 12a, 12b, 12c, and 12d that are arranged away from one another, in between the two flat-plate ground electrodes 11a and 11b that are arranged face to face in parallel to each other, in a perpendicular direction and in a horizontal direction with respect to opposite sides of the flat-plate ground electrodes 11a and 11b.

In addition, an interval between the wire-like high-voltage applying electrodes 12a and 12c that are arranged away from each other in a direction horizontal to the opposite sides of the flat-plate ground electrodes 11a, 11b is set 1 to 3 times larger than a distance between the flat-plate ground electrode 11a, 11b and the wire-like high-voltage applying electrodes 12a and 12c; 12b and 12d closest to the flat-plate ground electrodes 11a, 11b. This preferably produces an effect of attaining uniform discharge throughout the gas flow space 10. In addition, if the interval between the wire-like high-voltage applying electrodes 12a and 12c is smaller than the above distance, the gas flow space decreases in its capacity for uniform discharge. In contrast, if the interval is above three times the distance, the uniform discharge cannot be attained throughout the gas flow space 10.

The gas treating apparatus 2 thus structured separates the substance to be treated through decomposition as below. When the gas to be treated “a” containing the substance to be treated is introduced into the gas treating apparatus 2, voltage is applied to the four wire-like high-voltage applying electrodes 12a to 12d by the power supply 13. In this way, non-equilibrium plasma is generated between the wire-like high-voltage applying electrodes 12a, 12c and the flat-plate ground electrode 11a through the barrier material 15a and between the wire-like high-voltage applying electrodes 12b, 12d and the flat-plate ground electrode 11b through the barrier material 15b. The non-equilibrium plasma separates the substance to be treated from the gas to be treated “a” flowing through the gas flow space 10, and the remaining gas is discharged to the outside of a treatment system as the treated gas “b”.

With the thus-structured gas treating apparatus 2 being provided with the four wire-like high-voltage applying electrodes 12a to 12d arranged away from one another in a perpendicular direction and in a horizontal direction with respect to opposite sides of the flat-plate ground electrodes 11a, 11b, the throughput for the substance to be treated can be improved.

### Third Embodiment

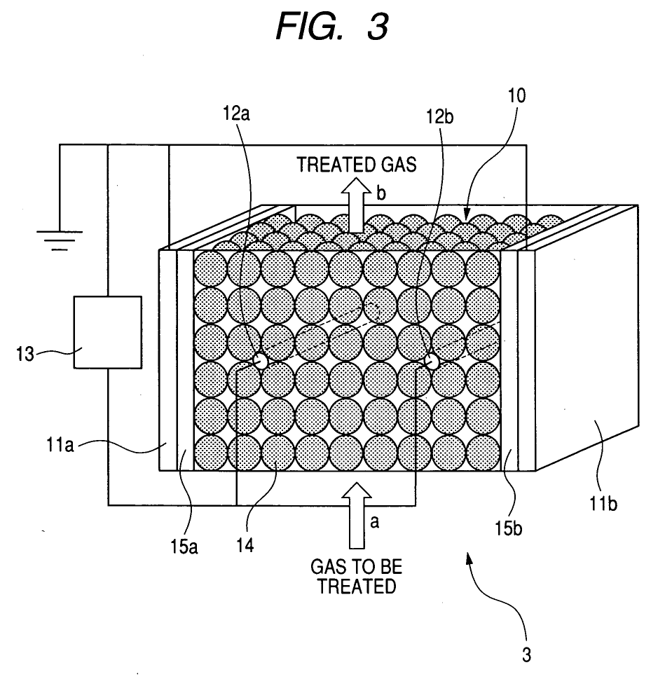

FIG. 3 shows a gas treating apparatus to which a gas treating method according to Third Embodiment is applied. As shown in FIG. 3, a gas treating apparatus 3 of this embodiment has inorganic dielectrics 14 packed between the flat-plate ground electrodes 11a and 11b that oppose each other to define the gas flow space in the apparatus.

The gas treating apparatus 3 thus structured separates the substance to be treated through decomposition as below. When the gas to be treated “a” containing the substance to be treated is introduced into the gas treating apparatus 3, voltage is applied to the two wire-like high-voltage applying electrodes 12a, 12b by the power supply 13. In this way, non-equilibrium plasma is generated between the wire-like high-voltage applying electrode 12a and the flat-plate ground electrode 11a through the barrier material 15a and the inorganic dielectrics 14, and between the wire-like high-voltage applying electrode 12b and the flat-plate ground electrode 11b through the barrier material 15b and the inorganic dielectric 14. The non-equilibrium plasma separates the substance to be treated from the gas to be treated “a” flowing through the gas flow space 10, and the remaining gas is discharged to the outside of a treatment system as the treated gas “b”.

### Fourth Embodiment

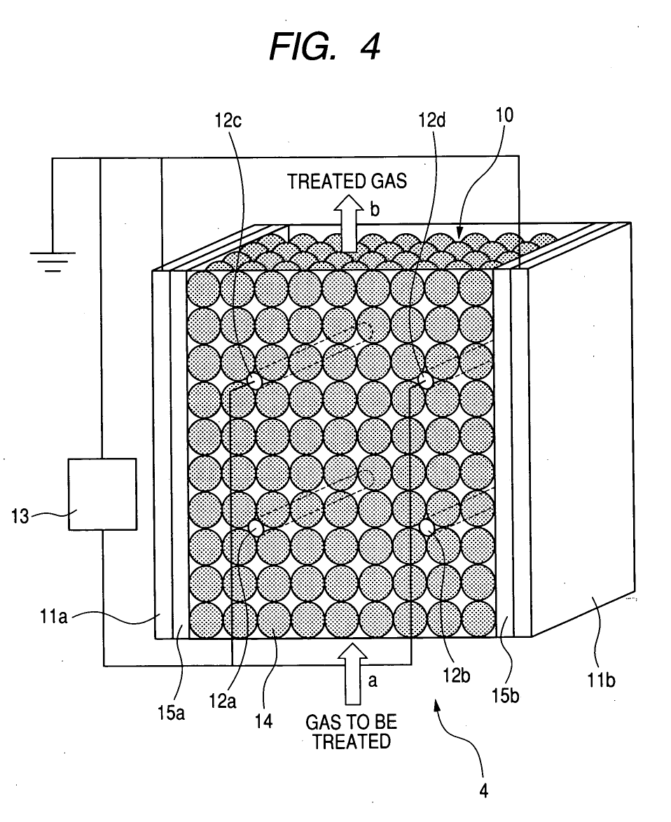

FIG. 4 shows a gas treating apparatus to which a gas treating method according to Fourth Embodiment is applied. As shown in FIG. 4, a gas treating apparatus 4 of this embodiment is structured as in Second Embodiment except that the inorganic dielectrics 14 are packed between the flat-plate ground electrodes 11a and 11b that oppose each other to define the gas flow space in the apparatus.

The gas treating apparatus 4 thus structured separates the substance to be treated through decomposition as below. When the gas to be treated “a” containing the substance to be treated is introduced into the gas treating apparatus 4, voltage is applied to the four wire-like high-voltage applying electrodes 12a to 12d by the power supply 13. In this way, non-equilibrium plasma is generated between the wire-like high-voltage applying electrodes 12a, 12c and the flat-plate ground electrode 11a through the barrier material 15a and the inorganic dielectrics 14, and between the wire-like high-voltage applying electrodes 12b, 12d and the flat-plate ground electrode 11b through the barrier material 15b and the inorganic dielectrics 14. The non-equilibrium plasma separates the substance to be treated from the gas to be treated “a” flowing through the gas flow space 10, and the remaining gas is discharged to the outside of a treatment system as the treated gas “b”.

The effects of the present invention will be described in more detail based on the following examples and comparative example, but the present invention is not limited to those examples.

Example 1 aims to demonstrate the effects of the present invention. Example 2 aims to examine an influence of an upscale gas treating apparatus on treatment effects. Further, Example 3 aims to demonstrate the effects of the present invention and examine the influence of the change in interval between the wire-like high-voltage applying electrodes on the treatment effect. Example 4 aims to examine an influence of an upscale apparatus on treatment effects and examine the influence of the change in interval between the wire-like high-voltage applying electrodes on the treatment effect. Comparative Example 1 aims to examine how the use of conventional techniques influences the treatment effect in contrast to Example 3.

### EXAMPLE 1

The gas treating apparatus 1 shown in FIG. 1 was used to carry out experiments for demonstrating effects of treating the substance to be treated. The two flat-plate ground electrodes 11a, 11b were made of an SUS plate having the width of 60 mm and the height of 10 mm, and two plates of quartz glass having the same shape and the thickness of 1 mm were arranged as the barrier materials 15a and 15b. The two wire-like high-voltage applying electrodes 12a, 12b were made of tungsten with the diameter of 0.3 mm. The distance between the wire-like high-voltage applying electrode 12a (12b) and the barrier material 15a (15b) laminated on the opposite side of the flat-plate ground electrode 11a (11b) was set to 4 mm. The interval between the wire-like high-voltage applying electrodes 12a and 12b was set to 12 mm. The gas flow space 10 in a reaction vessel had the capacity of 12 cm³.

As the gas to be treated “a”, an Air (general air mainly containing nitrogen and oxygen) base gas containing 100 ppm of NO was used and was allowed to flow in the reaction vessel at a flow rate of 2.4 L/min. Next, the voltage of 14 kVp-p was applied between the wire-like high-voltage applying electrode 12a and the flat-plate ground electrode 11a and between the wire-like high-voltage applying electrode 12b and the flat-plate ground electrode 11b to generate plasma discharge for treating the Air base gas. The treated gas “b” discharged from the reaction vessel was analyzed by an NOx analyzer. The analysis result shows that 99.99% or more of NO could be treated.

In this case, adopted as the NOx analyzer was an NOx-O₂ measuring apparatus (“NOA-7000” available from Shimadzu Corp.). This measuring apparatus is used as NOx analyzers of the following examples and comparative example.

### EXAMPLE 2

The gas treating apparatus 2 shown in FIG. 2 was used to carry out experiments for examining an influence of the upscale apparatus on the effect of treating the substance to be treated. The two flat-plate ground electrodes 11a, 11b were made of an SUS plate having the width of 60 mm and the height of 25 mm, and two plates of quartz glass having the same shape and the thickness of 1 mm were arranged as the barrier materials 15a and 15b. The four wire-like high-voltage applying electrodes 12a to 12d were made of tungsten with the diameter of 0.3 mm. The distance between the wire-like high-voltage applying electrode 12a (12b) and the barrier material 15a (15b) laminated on the opposite side of the flat-plate ground electrode 11a (11b) was set to 4 mm. The interval between the wire-like high-voltage applying electrodes 12a and 12b arranged in a direction perpendicular to the opposite sides of the flat-plate ground electrodes 11a, 11b was set to 12 mm. The interval between the wire-like high-voltage applying electrodes 12a and 12c arranged in a direction horizontal to the opposite sides of the flat-plate ground electrodes 11a, 11b was set to 15 mm. The gas flow space 10 in the reaction vessel had the capacity of 30 cm³.

As the gas to be treated “a”, an Air (general air mainly containing nitrogen and oxygen) base gas containing 100 ppm of NO was used and was allowed to flow in the reaction vessel at a flow rate of 6.0 L/min. Next, the voltage of 14 kVp-p was applied between the wire-like high-voltage applying electrode 12a and the flat-plate ground electrode 11a and between the wire-like high-voltage applying electrode 12b and the flat-plate ground electrode 11b to generate plasma discharge for treating the Air base gas. The treated gas “b” discharged from the reaction vessel was analyzed by an NOx analyzer. The analysis result shows that NO was treated at a rate of 99.99% or more.

### EXAMPLE 3

The gas treating apparatus 3 shown in FIG. 3 was used to carry out experiments for demonstrating the effect of treating the substance to be treated. The two flat-plate ground electrodes 11a, 11b were made of an SUS plate having the width of 60 mm and the height of 10 mm, and two plates of quartz glass having the same shape and the thickness of 1 mm were arranged as the barrier materials 15a and 15b. The two wire-like high-voltage applying electrodes 12a, 12b were made of tungsten with the diameter of 0.3 mm. The distance between the wire-like high-voltage applying electrode 12a (12b) and the barrier material 15a (15b) laminated on the opposite side of the flat-plate ground electrode 11a (11b) was set to 4 to 7.5 mm. The interval between the wire-like high-voltage applying electrodes 12a and 12b was set to 5 to 12 mm. The gas flow space 10 in the reaction vessel had the capacity of 12 cm³. Packed into the reaction vessel were spherical γ alumina particles having a particle size of 3 mm as the inorganic dielectrics 14.

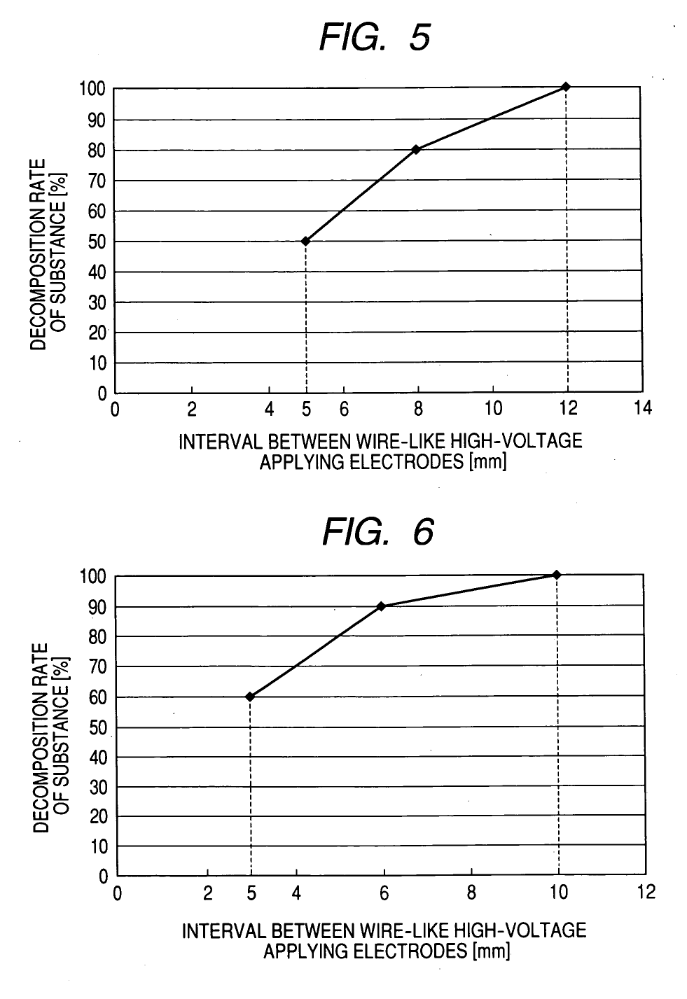

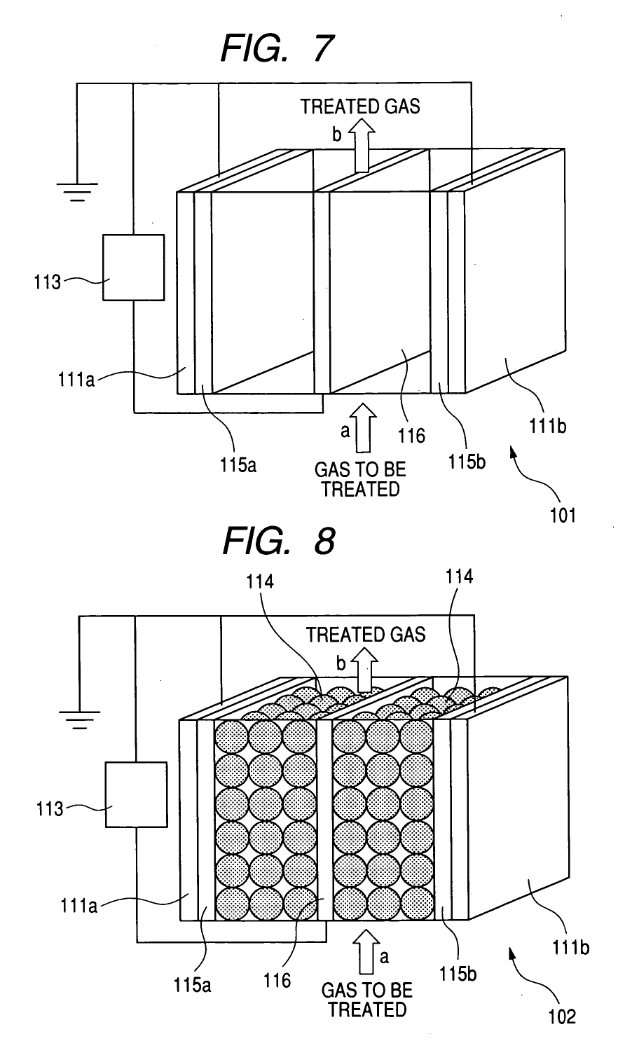

As the gas to be treated “a”, an Air (general air mainly containing nitrogen and oxygen) base gas containing 100 ppm of NO was used and was allowed to flow in the reaction vessel at a flow rate of 2.4 L/min. Next, the voltage of 12.5 kVp-p was applied between the wire-like high-voltage applying electrode 12a and the flat-plate ground electrode 11a and between the wire-like high-voltage applying electrode 12b and the flat-plate ground electrode 11b to generate plasma discharge for treating the Air base gas. The treated gas “b” discharged from the reaction vessel was analyzed by an NOx analyzer. As a result of the analysis, as shown in FIG. 5, the larger the interval between the wire-like high-voltage applying electrodes 12a and 12b is made, the higher the decomposition rate of the substance to be treated becomes.

### EXAMPLE 4

The gas treating apparatus 4 shown in FIG. 4 was used to carry out experiments for examining an influence of the upscale apparatus on the effect of treating the substance to be treated. The two flat-plate ground electrodes 11a, 11b were made of an SUS plate having the width of 60 mm and the height of 25 mm, and two plates of quartz glass having the same shape and the thickness of 1 mm were arranged as the barrier materials 15a and 15b. The four wire-like high-voltage applying electrodes 12a to 12d were made of tungsten with the diameter of 0.3 mm. The distance between the wire-like high-voltage applying electrode 12a (12b) and the barrier material 15a (15b) laminated on the opposite side of the flat-plate ground electrode 11a (11b) was set to 4 mm. The interval between the wire-like high-voltage applying electrodes 12a and 12b arranged in a direction perpendicular to the opposite sides of the flat-plate ground electrodes 11a, 11b was set to 3 to 10 mm. The interval between the wire-like high-voltage applying electrodes 12a and 12c arranged in a direction horizontal to the opposite sides of the flat-plate ground electrodes 11a, 11b was set to 12 mm. The gas flow space 10 in the reaction vessel had the capacity of 30 cm³. Packed into the reaction vessel were spherical γ alumina particles having a particle size of 3 mm as the inorganic dielectrics 14.

As the gas to be treated “a”, an Air (general air mainly containing nitrogen and oxygen) base gas containing 100 ppm of NO was used and was allowed to flow in the reaction vessel at a flow rate of 6.0 L/min. Next, the voltage of 12.5 kVp-p was applied between the wire-like high-voltage applying electrodes 12a, 12c and the flat-plate ground electrode 11a and between the wire-like high-voltage applying electrodes 12b, 12d and the flat-plate ground electrode 11b to generate plasma discharge for treating the Air base gas. The treated gas “b” discharged from the reaction vessel was analyzed by an NOx analyzer. As a result of the analysis, as shown in FIG. 6, the larger the interval between the wire-like high-voltage applying electrodes 12a and 12b is made, the higher the decomposition rate of the substance to be treated becomes. In addition, by arranging the four wire-like high-voltage applying electrodes 12a to 12d away from one another in a perpendicular direction and a horizontal direction with respect to opposite sides of the flat-plate ground electrodes 11a, 11b, the throughput for the substance to be treated can be improved.

### COMPARATIVE EXAMPLE 1

A conventional apparatus 102 shown in FIG. 8 was used to carry out experiments for examining the influence thereof on the effect of treating the substance to be treated in contrast to Example 3. Two flat-plate ground electrodes 111a, 111b were made of an SUS plate having the width of 60 mm and the height of 10 mm, and two plates of quartz glass having the same shape and the thickness of 1 mm were arranged as barrier materials 115a and 115b. An SUS plate having the width of 60 mm and the height of 10 mm was used for a flat-plate high-voltage applying electrode 116. The distance between the flat-plate high-voltage applying electrode 116 and the barrier materials 115a, 115b laminated on the opposite sides of the flat-plate ground electrodes 111a, 111b was set to 10 mm. The gas flow space 10 in the reaction vessel had the capacity of 12 cm³. Packed into the reaction vessel were spherical γ alumina particles having a particle size of 3 mm as inorganic dielectrics 114.

As the gas to be treated “a”, an Air (general air mainly containing nitrogen and oxygen) base gas containing 100 ppm of NO was used and allowed to flow in the reaction vessel at a flow rate of 2.4 L/min. Next, the voltage of 12.5 kVp-p was applied between the flat-plate high-voltage applying electrode 116 and the flat-plate ground electrodes 111a, 111b to generate plasma discharge for treating the Air base gas. The treated gas “b” discharged from the reaction vessel was analyzed by an NOx analyzer. The analysis result shows that 25% of NO was treated.

This application claims priority from Japanese Patent Application No. 2004-176857 filed Jun. 15, 2004, which is hereby incorporated by reference herein.

1. A gas treating method comprising the step of:
generating non-equilibrium plasma in a gas flow space; and
treating a gas containing a substance to be treated using the non-equilibrium plasma,
wherein the non-equilibrium plasma is generated by using at least two wire-like high-voltage applying electrodes that are arranged away from each other, in between at least two flat-plate ground electrodes that are arranged face to face in parallel to each other to define the gas flow space, in a direction perpendicular to opposite sides of the flat-plate ground electrodes.

2. The gas treating method according to claim 1, wherein the at least two wire-like high-voltage applying electrodes are used, which are arranged away from each other, in between the opposing flat-plate ground electrodes, in a direction horizontal to opposite sides of the flat-plate ground electrodes.

3. The gas treating method according to claim 1, wherein an inorganic dielectric is packed between the opposing flat-plate ground electrodes.

4. The gas treating method according to claim 1, wherein the wire-like high-voltage applying electrodes are arranged such that an axial direction thereof extends in parallel to the opposite sides of the flat-plate ground electrodes and extends orthogonally to a gas flow direction.

5. The gas treating method according to claim 1, wherein the wire-like high-voltage applying electrode is made up of a wire having a diameter of 5 mm or smaller.

6. The gas treating method according to claim 1, wherein an interval between the wire-like high-voltage applying electrodes arranged away from each other in a direction perpendicular to the opposite sides of the flat-plate ground electrodes is set 0.5 to 20 times larger than a distance between the flat-plate ground electrode and the wire-like high-voltage applying electrode closest to the flat-plate ground electrode.

7. The gas treating method according to claim 2, wherein an interval between the wire-like high-voltage applying electrodes arranged away from each other in a direction horizontal to the opposite sides of the flat-plate ground electrodes is set 1 to 3 times larger than a distance between the flat-plate ground electrode and the wire-like high-voltage applying electrode closest to the flat-plate ground electrode.

8. A gas treating apparatus having a gas flow space for generating non-equilibrium plasma to treat a gas containing a substance to be treated, comprising:
at least two flat-plate ground electrodes that are arranged face to face in parallel to each other to define the gas flow space; and
at least two wire-like high-voltage applying electrodes that are arranged away from each other, in between the opposing flat-plate ground electrodes, in a direction perpendicular to opposite sides of the flat-plate ground electrodes.

9. The gas treating apparatus according to claim 8, wherein the at least two wire-like high-voltage applying electrodes are used, which are arranged away from each other, in between the opposing flat-plate ground electrodes, in a direction horizontal to opposite sides of the flat-plate ground electrodes.

10. The gas treating apparatus according to claim 8, wherein an inorganic dielectric is packed between the opposing flat-plate ground electrodes.

11. The gas treating apparatus according to claim 8, wherein the wire-like high-voltage applying electrodes are arranged such that an axial direction thereof extends in parallel to the opposite sides of the flat-plate ground electrodes and extends orthogonally to a gas flow direction.

12. The gas treating apparatus according to claim 8, wherein the wire-like high-voltage applying electrode is made up of a wire having a diameter of 5 mm or smaller.

13. The gas treating apparatus according to claim 8, wherein an interval between the wire-like high-voltage applying electrodes arranged away from each other in a direction perpendicular to the opposite sides of the flat-plate ground electrodes is set 0.5 to 20 times larger than a distance between the flat-plate ground electrode and the wire-like high-voltage applying electrode closest to the flat-plate ground electrode.

14. The gas treating apparatus according to claim 9, wherein an interval between the wire-like high-voltage applying electrodes arranged away from each other in a direction horizontal to the opposite sides of the flat-plate ground electrodes is set 1 to 3 times larger than a distance between the flat-plate ground electrode and the wire-like high-voltage applying electrode closest to the flat-plate ground electrode.
